(19) United States
(12) Patent Application Publication
(10) Pub. No.: US 2018/0332764 A1
(43) Pub. Date: Nov. 22, 2018

(54) Distributor for Manure Injection System

(71) Applicant: Raymond Zimmerman, Cantril, IA (US)

(72) Inventor: Raymond Zimmerman, Cantril, IA (US)

(21) Appl. No.: 15/599,309

(22) Filed: May 18, 2017

(51) Int. Cl. A01C 23/02; A01C 5/06

(52) U.S. Cl. CPC A01C 23/022; A01C 5/062

(57) ABSTRACT

A distributor for a manure injection system is disclosed. The main distributor includes a distributor housing with an inlet and a plurality of outlets for distributing a main flow of manure into a plurality of separate streams of manure. A screed barrel is disposed within the distributor housing and has a central opening in communication with the inlet of the distributor housing. The screed barrel includes a plurality of screed holes. A screed paddle is disposed within the screed barrel for screeding the main flow of manure through the plurality of screed holes. A manure distributor associated with the main distributor has a gate shaft with a gate valve disposed in each of the plurality of outlets. A biasing member is operably attached to the gate shaft to bias each gate valve toward the closed position for distributing even amounts of the separate streams of manure to each manure injector.

### FIELD OF THE INVENTION

The present invention relates to manure distribution and earthen injection. More particularly, but not exclusively, the present invention relates to a distributor for a manure injection system.

### BACKGROUND

Manure injection systems are used in agriculture to inject animal manure into the soil for adding nutrients. In slurry form, manure is extremely viscous and dense, but not necessarily throughout thereby posing difficulty in controlling even in-field distribution and application. Moreover, heavy viscous flows are known to be difficult to evenly separate and distribute, particularly at low pressures. Therefore, what is needed is a manure handling system that can take a heavy viscous flow of manure and evenly separate, distribute and inject it into the soil.

### SUMMARY

Therefore, it is a primary object, feature, or advantage of the present invention to improve over the state of the art.

It is a further object, feature, or advantage of the present invention to provide a manure injection system that addresses existing problems in the art.

It is a still further object, feature, or advantage of the present invention to evenly separate heavy, viscous manure flows within a manure distributor.

Another object, feature, or advantage is to address problems in the art relating to separating and distributing a flow of manure under low pressure.

Yet another object, feature, or advantage is to provide a distributor for a manure injection system that includes anti-clogging features.

In accordance with at least one exemplary embodiment, a distributor for a manure injection system is disclosed. The main distributor includes a distributor housing with an inlet and a plurality of outlets for distributing a main flow of manure into a plurality of separate streams of manure. A screed barrel is disposed within the distributor housing. The screed barrel has a central opening in communication with the inlet of the distributor housing for receiving the main flow of manure. The screed barrel includes a plurality of screed holes in a wall of the screed barrel. A screed paddle is also disposed within the screed barrel. The screed paddle is rotatably actuated against the wall of the screed barrel for screeding the main flow of manure through the plurality of screed holes to the plurality of outlets. A manure distributor associated with the main distributor housing has a gate shaft with a gate valve disposed in each of the plurality of outlets. The gate valve has an open position configured to communicate one of the plurality of separate streams of manure to a manure injector and a closed position configured to occlude manure flow to the manure injector. A biasing member is operably attached to the gate shaft to bias each gate valve toward the closed position for distributing even amounts of the separate streams of manure to each manure injector.

In accordance with at least one other exemplary embodiment, an agricultural toolbar configured for manure injection is disclosed. The agricultural toolbar has a frame operably supporting one or more coulter blades. A manure injection system is operably attached to the frame. The manure injection system has a distributor housing with an inlet and a plurality of outlets for distributing a main flow of manure into a plurality of separate streams of manure. A screed member is disposed within the distributor housing in communication with the inlet of the distributor housing for receiving the main flow of manure. The screed member includes a plurality of screed holes passing through a wall of the screed member. A screed paddle is disposed proximate the screed member. The screed paddle is actuated against the wall of the screed member for screeding the main flow of manure through the plurality of screed holes to the plurality of outlets. A valve assembly is disposed at an opening to each of the plurality of outlets. The valve assembly has an open position configured to communicate one of the plurality of separate streams of manure to a manure injector operably attached to the toolbar and a closed position configured to occlude manure flow to the manure injector.

In accordance with at least yet another exemplary embodiment, a method for controlling earthen manure injection in agricultural applications is disclosed. The method includes providing a manure distributor housing having an inlet and a plurality of outlets for distributing a main flow of manure into a plurality of separate streams of manure. The main flow of manure is introduced into a screed barrel disposed within the distributor housing. The main flow of manure is screeded through a plurality of screed holes disposed in a wall of the screed barrel by moving a screed paddle against the wall of the screed barrel. A gate valve disposed in each of the plurality of outlets is biased to a closed position for distributing even amounts of the separate streams of manure from the screed barrel to a manure injector.

One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by an objects, features, or advantages stated herein.

### BRIEF DESCRIPTION OF THE DRAWINGS

Illustrated embodiments of the disclosure are described in detail below with reference to the attached drawing figures, which are incorporated by reference herein.

FIG. 1 is a pictorial representation of a manure injection system on a tool bar with disc injectors in accordance with an illustrated embodiment of the present invention.

FIG. 2 is a front perspective view of the manure distributor shown in FIG. 1.

FIG. 3 is a side perspective view of the manure distributor.

FIG. 4 is a perspective view illustrating the opposite side of the manure distributor shown in FIG. 3.

FIG. 5 is a back perspective view of the manure distributor.

FIG. 6 is a perspective view from the front of the inside of the manure distributor.

FIG. 7 is a perspective view of a manure screed barrel and screed paddles of the manure distributor.

FIGS. 8(A)-(B) are a perspective views of a manure distributor, gate shaft and gates valves in accordance with an illustrated embodiment of the present invention.

FIG. 9 is an enlarged perspective view of the gate shaft, gate valves and distributor outlets shown in FIG. 8 with the gate valve in a closed position relative to the gate sleeve in accordance with an illustrative embodiment of the present invention.

FIG. 10 is a top perspective view of a distributor actuator and biasing system in accordance with an illustrated embodiment of the present invention.

FIG. 11 is a perspective view of the gate shaft and gate valves.

FIG. 12 is a perspective view of the gate valve sleeve of the distributor outlets.

FIG. 13 is a perspective view of the gate valve in FIG. 9 shown in an open position.

### DETAILED DESCRIPTION

The invention is not to be limited to the particular embodiments described herein. In particular, the invention contemplates numerous variations for manure distribution and injection in a field. The foregoing description has been presented for purposes of illustration and description. It is not intended to be an exhaustive list or limit any of the invention to the precise forms disclosed. It is contemplated that other alternatives or exemplary aspects are considered included in the invention. The description is merely examples of embodiments, processes or methods of the invention. It is understood that any other modifications, substitutions, and/or additions can be made, which are within the intended spirit and scope of the invention.

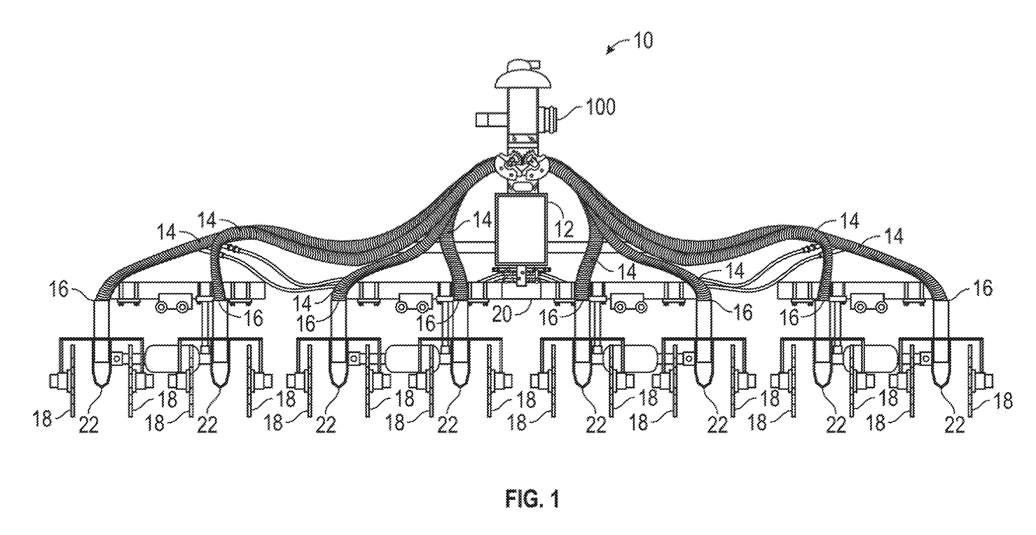

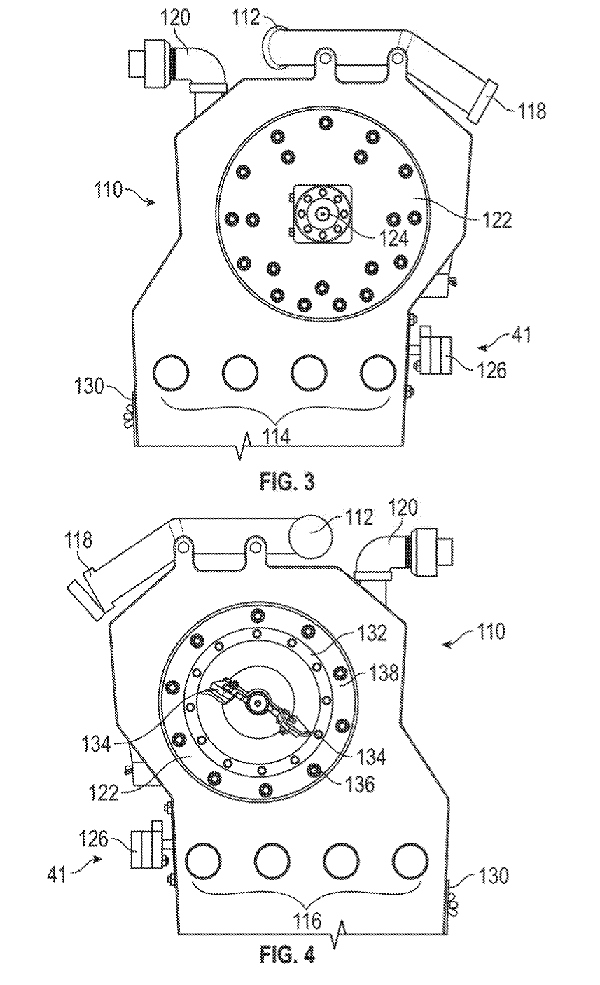

FIGS. 1-13 provide by illustration various aspects of a distributor for a manure injection system and an agricultural toolbar configured for earthen manure injection. In at least one application, a manure injection system 10 includes an agricultural toolbar 20 having a number of coulter blades 18 configured for engaging and opening the soil in a field. The toolbar 20 is configured to be drawn behind an agricultural vehicle, such as a tractor (not shown). A stanchion 12 can be configured atop the toolbar 20 for supporting one or more components of a manure injection system. The toolbar 20 can also be configured to operably support one or more components of a manure injection system. A manure distributor housing 110 is operably attached to the toolbar 20. In at least one aspect, the manure distributor housing 110 is operably attached atop a stanchion 12 of the toolbar 20. A plurality of conduits 14 are operably configured between the manure distributor housing 110 and the coulter blades 18. The each of the plurality of conduits has an inlet operably attached at the manure distributor housing and discharge end 16 in operably communication with a manure injector 22. The conduit 14 can be of various size tubing, such as tubing ranging from 1.5-4 inches in diameter or larger. Flexible corrugated tubing with a smooth inner wall can be used for each run between the manure distributor housing 110 and each manure injector 22. The manure injection system 10 can be configured with 2, 3, 4, 5, 6, or more manure injectors 22 on each side of the toolbar 20 that are fed manure from the manure distributor housing 110. In number of coulter discs can be used to incorporate the manure into the soil.

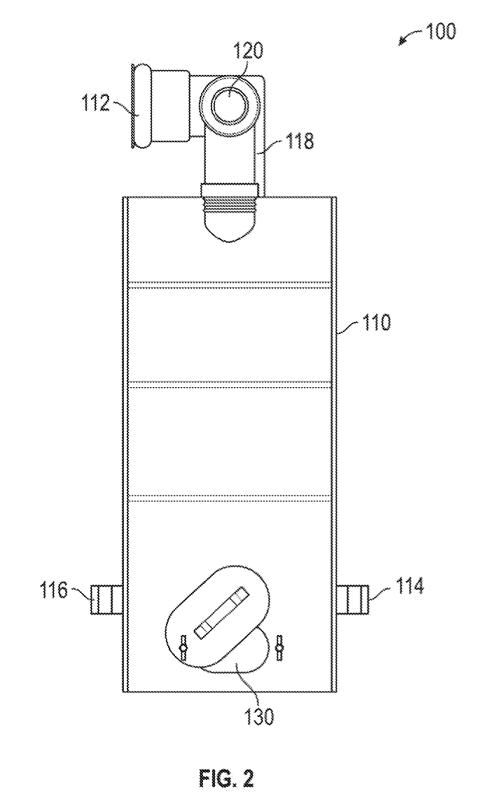

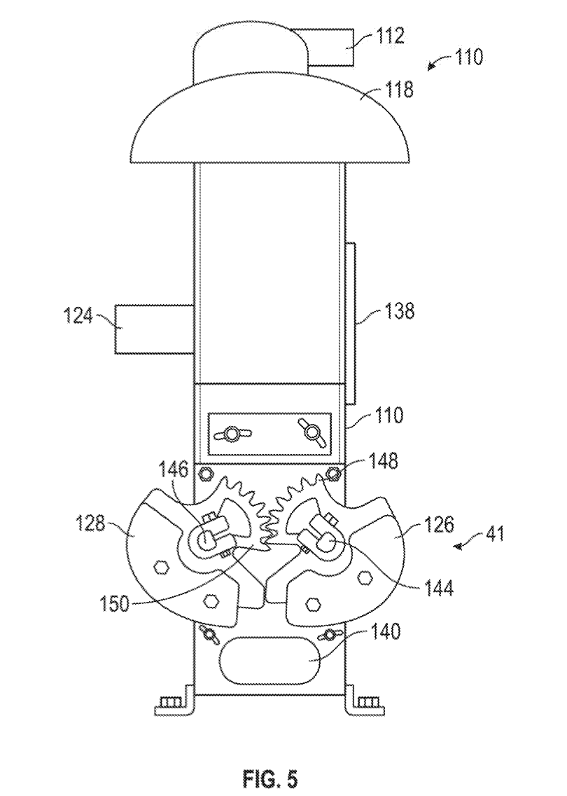

The manure injection system 10 includes a manure distributor housing 110 shown by various illustrations in FIGS. 2-5. The distributor housing 110 can be configured from an enclosed housing having an interior portion defined by the outer walls of the housing. The outer walls of the housing can be configured from steel, stainless steel, or non-ferrous metals, or a combination of one or more of these and/or other materials. Walls of the housing can be formed into an enclosed body by securing to a subframe, by welding, or a combination of both. The housing 110 includes a central opening 138 configured to receive a flow of manure from a manure source (not shown), such as a manure trailer/tank. In one aspect, manure is pumped from a manure source to the central opening 138 of the housing 110 through, for example, a hose, conduit or line connected between a manure source and the central opening 138 of the housing 110. The housing 110 can include one or more cleanouts for accessing the inside. In one aspect, cleanouts 130, 140 are disposed in vertical walls of the housing. Cleanout 130, 140 can be disposed in front and back vertical walls of housing 110, as best shown in FIGS. 2 and 5. Cleanouts 130, 140 can be disposed in the housing near the bottom surface or between the bottom surface of the housing and the screed barrel 122. Troubleshooting, inspection and repairs can be conducted through one or more of the cleanouts 130, 140. Access points can be disposed in other walls and locations of the housing 110. An exhaust 120 can also be operably attached to the housing 110 for fumes, exhaust and other emissions to pass outside the housing 110. Components for connecting and handling the flow of manure slurring into the housing can also be configured on/at the housing 110. In one aspect, a manure handling fitting 118 is disposed atop the housing 110. The fitting can include an opening 112 for receiving a slurry of manure.

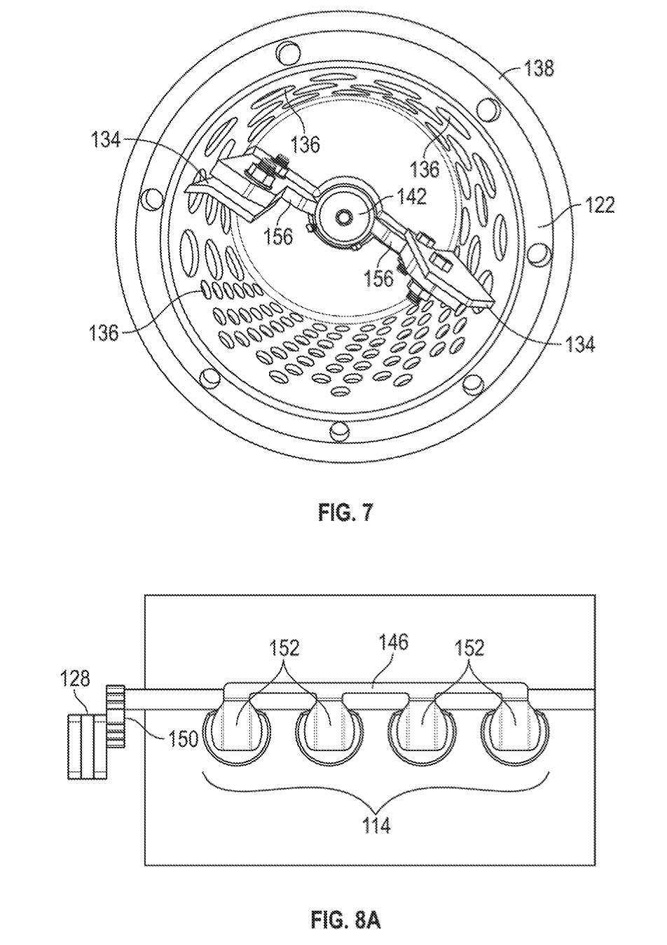

In at least one aspect as best shown in FIG. 7, a screed barrel 122 is operably disposed within the manure distributor housing 110. The screed barrel 122 is formed from a wall 132. The barrel wall 132 can be formed having the shape of a barrel with a closed end and an open end. The wall 132 can be formed in circular and non-circular shapes. The wall 132 can also be formed in planar and non-planar shapes. The wall 132 material can be configured from steel, stainless steel, or non-ferrous metals, or a combination of one or more of these and/or other materials. In one instance, opposing vertical ends of the screed barrel 122 can be fixed to one or both opposing vertical walls of the housing 110 whereby the open end of the screed barrel 122 is disposed in direct communication with the central opening 138 of the housing 110 to receive a stream of manure in slurry-like form. In at least one configuration, a vertical wall of the housing 110 can form a closed end of the screed barrel 122.

Disposed within the screed barrel 122 are one or more screed paddles 134 operably secured by an arm 156 attached to a shaft 142. The shaft is driven by a motor 124. The motor 124 can be a hydraulic, pneumatic, gas, or electric motor. In one configuration, the motor 124 is a hydraulic motor operable using hydraulics from another agricultural implement. The screed paddles 134 are oriented generally parallel and in near-touching proximity to the wall 132 of the screed barrel 122. In another aspect, the screed paddles 134 can be oriented at an angle in both the horizontal and/or vertical directions and in near-touching proximity to the wall 132 of the screed barrel 122. The screed paddles 134 can include a replaceable screed blade for quick repair when damaged or worn. In operation, the motor 124 imparts movement to the screed paddles 134. According to one configuration, the motor 124 imparts rotation to the screed paddles 134 via the shaft 142 and arms 156. Alternatively, the motor 124 may be configured to impart linear or non-linear movement to the screed paddles 134. For example, screed paddles 134 can also be configured to move in a reciprocating motion back and forth across any one of the disclosed shapes of the wall 132. The motor 124 can be configured to impart movement to the wall 132 and/or paddles 134. Alternatively, the motor 124 can be configured to impart movement to the wall 132 of the screed barrel 122. The screed paddles 134 can also be operably fixed to one or both vertical walls of the housing 110 and the screed barrel 122 moved by the motor 124 relative to the fixed screed paddles 134. A plurality of screed holes 136 pass through the wall 132 of the screed barrel 122. The screed holes 136 can be of varying shape and sizes. Certain portions of the wall 132 can be configured with the same size screed holes 136. Other portions of the wall 132 can be configured with the same or different sized screed holes 136. In one aspect, lower portions of the wall 132 house smaller screed holes 136 while upper portions of the wall house larger screed holes. In operation, portions of the manure slurry, including the liquid portion, are screed through the smaller screed holes while larger matter within the manure slurry are screed through the larger screed holes. Position of the specific hole size in the wall 132 can control where smaller, larger and liquid portions of the manure slurry are screed through the screed barrel 122. The closed end of the screed barrel 122 can also be configured with screed holes 136 and screed paddles 134 moved by the motor 124. For example, the closed end of the screed barrel 122 can be disposed in a spaced apart relation to a vertical wall of the housing 110 to allow for manure passage between the vertical wall and the closed end of the screed barrel 122. The manure slurry is introduced into the housing 110 through the central opening 138 into the screed barrel 122. Operation of the screed paddles 134 screeds the manure slurry through the screed holes 136. The screeded manure slurry travels downward into the bottom of the housing 110.

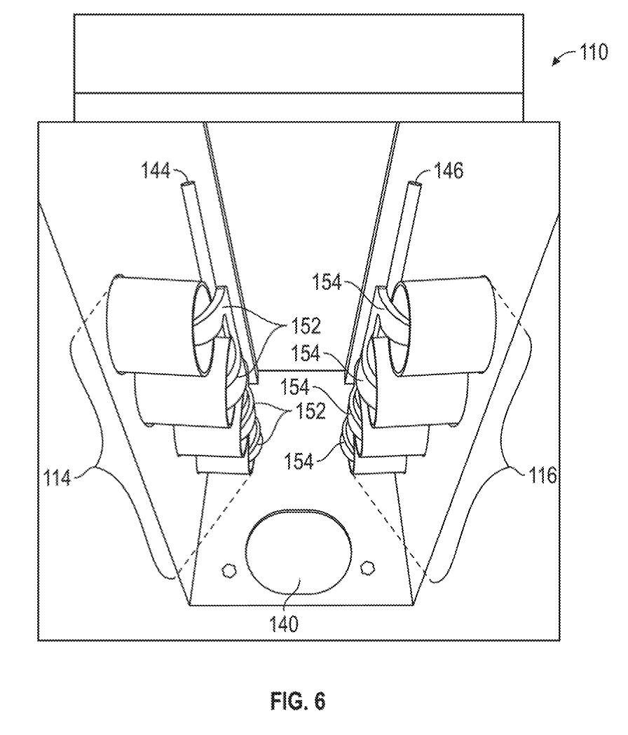

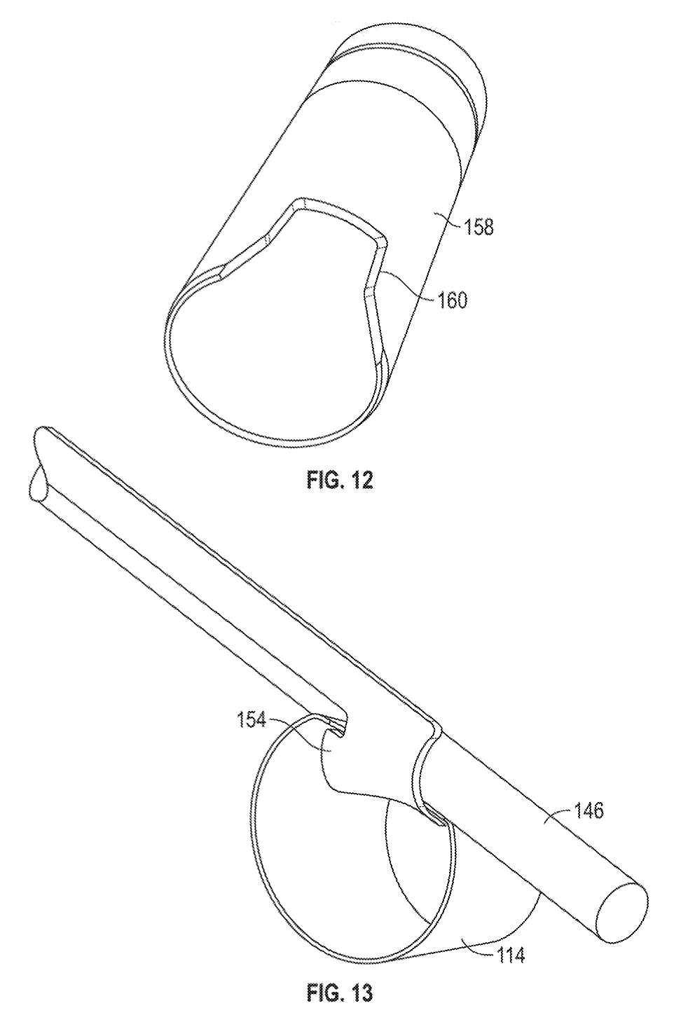

A plurality of outlets 114, 116 are disposed in one or more of the vertical walls of the housing 110 between the bottom wall of the housing and the screed barrel 122. In one aspect, the plurality of outlets are configured as a sleeve 158 as best shown in FIG. 12. The sleeve 158 is rigidly attached to the vertical wall of the housing 110. The sleeve 158 can be circular or non-circular in shape. The sleeve 158 includes opposing ends with openings. One end of the sleeve 158 includes a notch 160 configured for receiving a gate valve 154 shown in FIG. 11. The notched end of the sleeve is disposed on the inside of the housing 110 while the opposing end of the sleeve 158 is disposed outside the housing 110. The sleeve 158 can be rigidly attached to a vertical wall of the housing 110 between the notched end and the opposing end as best shown in FIG. 6. The sleeve 158 can be configured from steel, stainless steel, or non-ferrous metals, or a combination of one or more of these and/or other materials. The number of sleeves 158 can vary. In one aspect, a pair of opposing vertical walls of the housing include at least 2, 3, 4, or more sleeves 158. A version with four sleeves 158 is shown in the figures, but the present invention contemplates other versions with more or less than four sleeves 158. The sleeves 158 can be disposed in opposing vertical walls of the housing 110 in same horizontal plane or in different horizontal planes. As shown in the figures, the sleeves 158 are arranged in the same horizontal plane between the front and back walls of the housing 110.

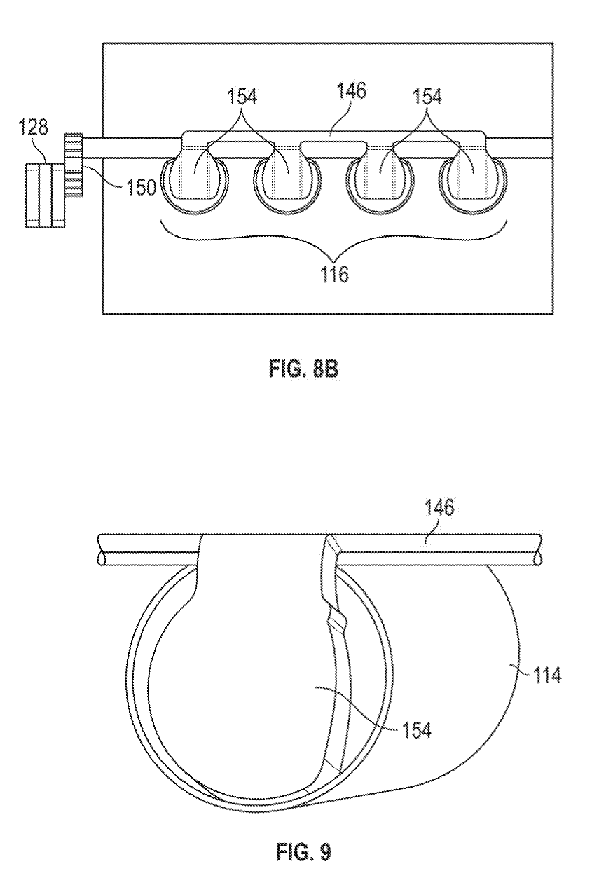

FIGS. 6-13 provide pictorial representations of a manure distributor and biasing mechanism 41 for controlling flows of manure slurry through the sleeves 158. Disposed within each of the notched ends of the sleeves 158 are gate valves 152, 154 as best shown in FIGS. 6 and 9. Each gate valve 152, 154 is accurately shaped to mimic the inner countered profile of the sleeves 158. In another aspect the gate valve is planar in shape and mimics the profile of a planar surface of sleeve with one or more planar surfaces. The gate valve may be shaped to the contour of any shape of sleeve. In the open position, as best shown in FIG. 13, the gate valve seats against the upper and inner countered profile of the sleeve. In a closed position, as best shown in FIGS. 8-9, the gate valve generally occludes the opening at the notched end of the sleeve 158. Each gate valve 152, 154 is seated within the sleeve generally toward the depth of the notch 160. The gate valve 152, 154 is able to rotate to a fully open position, in part, due to the notch 160 in each sleeve 158. One set of gate valves 152 are operably attached to a gate shaft 144. Another set of gate valves 154 are operably attached to a gate shaft 146. Movement of gate shafts 144, 146 imparts movement to gate valves 152, 154. In one aspect, movement of gate shaft 144 between open and closed positions simultaneously moves gate valves 152 to a corresponding open and closed position. Similarly, movement of gate shaft 146 between open and closed positions simultaneously moves gate valves 154 to a corresponding open and closed position. In the open position as best shown in FIG. 13, the manure slurry in the bottom of the housing 110 is able to pass through the sleeves 158 and out respective outlets 114, 116 on each side of the housing 110. In the closed position as best shown in FIGS. 8(A)-8(B), the manure slurry is generally occluded from passing through the sleeves 158 into respective outlets 114, 116. A greater volume of manure slurry can pass through sleeves 158 and into respective housing outlets 114, 116 as the gate valves 152, 154 move from the closed position to the open position. Similarly, a decreasing smaller volume of the manure slurry passes through the sleeves 158 as the gate valves 152, 154 move from the open position to the closed position. FIG. 6 illustrates the gate valves 152, 154 in a halfway open position. The gate shaft 144, 146 and gate valves 152, 154 can be configured from steel, stainless steel, or non-ferrous metals, or a combination of one or more of these and/or other materials. The gate shaft 144, 146 can be configured from round, square, or other elongated shaped members. The gate valves 152, 154 can be operably secured to the gate shaft 144, 146 by a weld or other securement hardware. The gate shafts 144, 146 can be configured between opposing vertical walls of housing 110. In one aspect, gate shafts 144, 146 extend at least between front and back vertical surfaces of housing 110 as best illustrated in FIGS. 8(A)-(B). As shown, the gate shafts 144, 146 are disposed above the sleeves; however, the gate shafts can be disposed below the sleeves with each gate valve 152, 154 extending upward into the notched end of each sleeve.

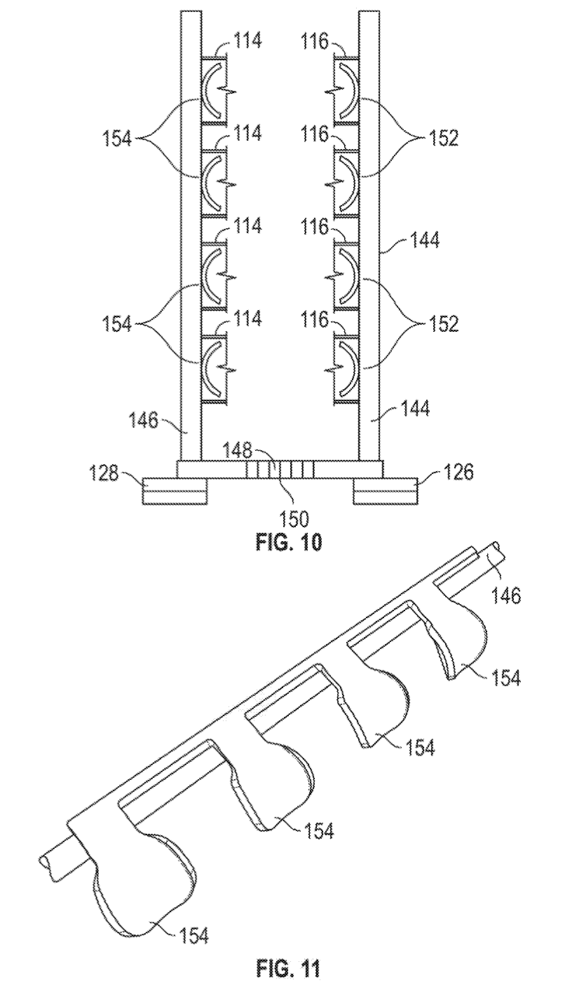

The manure distributor and biasing mechanism 141 also includes, in at least one aspect, gate shafts 144, 146 extending through a vertical wall of the housing 110. In one configuration, shafts 144, 146 extend through a hole in the rear vertical wall of housing 110, as best illustrated in FIG. 8, and terminate in operable connection to a biasing mechanism 141. The biasing mechanism 141 includes biasing members 126, 128 operably attached to respective gate shafts 144, 146. The biasing members 126, 128 are configured to bias respective gate shafts 144, 146 and gate valves 152, 154 to the closed position shown in FIGS. 8(A)-(B). As best shown in FIGS. 5 and 8(A)-(B), the biasing members 126, 128, in at least one aspect, can be configured from one or more weights operably secured to respective gate shafts 144, 146 to bias the gate shafts and respective gate valves 152, 154 toward the closed position. The gate shafts 144, 146 can also be biased to the closed position by a spring-actuated, pneumatic-actuated, hydraulic-actuated, or electric-actuated solenoid or device. The biasing members 126, 128 can be configured to change the amount of bias applied the gate shafts 144, 146 and gate valves 152, 154 to control the volumetric flow of manure slurry passing through the sleeves and respective outlets 114, 116 in the housing 110. Increasing the amount of bias applied to the gate shafts 144, 146 and gate valves 152, 154 requires greater pressure from the manure slurry in the bottom of the housing 110 to overcome the applied bias thereby moving the gate valves 152, 154 from the closed position toward the open position. Changing the bias of the biasing members 126, 128 controls the rate at which the manure slurry is metered through the sleeves 158. A decreased rate of metering can be achieved by increasing the bias applied by respective biasing members 126, 128. Similarly, an increased rate of metering can be achieved by decreasing the bias applied by respective biasing members 126, 128. Movement of gate shaft 144 can be tied to movement of gate shaft 146 by tying together movement of respective biasing members 126, 128. FIGS. 5 and 10 illustrate biasing members 126, 128 tied together by respective cogs 148, 150. In this configuration, neither gate shaft 144, 146 can rotate independently of the other. Respective cogs 148, 150 engage one another to tie movement of the gate shafts 144, 146 together. In operation, the tied movement of respective gate shafts 144, 146 keeps respective gate valves 152, 154 from opening or closing at different rates or different degrees thereby maintaining a consistent and even flow rate of the manure slurry passing through each of the sleeves and into respective outlets 114, 116 of the distributor housing 110. Although cogs 148, 150 are shown for tying movement of respective gate shafts 144, 146 together, other mechanical, electrical, pneumatic, or hydraulic devices can be configured to make movement of one gate shaft only possible with movement of the other gate shaft. For example, respective biasing members 126, 128 can be configured as spring-biased members that apply an equal and opposite biasing force to each of the gate shafts 144, 146. Respective biasing members 126, 128 can also be configured with an electrical, hydraulic, or pneumatic biasing device that apply an equal and opposite biasing force to respective gate shafts 144, 146 to bias gate shafts 144, 146 to the closed position.

What is claimed is:

1. A distributor for a manure injection system, comprising:
a distributor housing having an inlet and a plurality of outlets for distributing a main flow of manure into a plurality of separate streams of manure;
a screed barrel disposed within the distributor housing, the screed barrel having a central opening in communication with the inlet of the distributor housing for receiving the main flow of manure, wherein the screed barrel includes a plurality of screed holes circumferentially disposed in a wall of the screed barrel;
a screed paddle disposed within the screed barrel, the screed paddle rotatably actuated against the wall of the screed barrel for screeding the main flow of manure through the plurality of screed holes to the plurality of outlets;
a manure distributor having a gate shaft with a gate valve disposed in each of the plurality of outlets, the gate shaft having an open position configured to communicate one of the plurality of separate streams of manure to a manure injector and a closed position configured to occlude manure flow to the manure injector; and
a biasing member operably attached to the gate shaft to bias each gate shaft and gate valve toward the closed position for distributing even amounts of the separate streams of manure to each manure injector.

2. The distributor of claim 1 further comprising:
at least a pair of the gate shafts with the gate valves disposed in each of the plurality of outlets.

3. The distributor of claim 2 further comprising:
a synchronizing member operably attached to the pair of gate shafts, wherein movement of one gate shaft is tied to movement of the other gate shaft thereby opening and closing each gate valve simultaneously and to the same degree for passing even amounts of the separate streams of manure past each gate valve.

4. The distributor of claim 1 wherein a closing force applied to the gate shaft by the biasing member is adjustable.

5. The distributor of claim 1 wherein the gate valve is arcuately shaped to seat flush against an inner wall of the outlet.

6. The distributor of claim 1 wherein the screed barrel is rigidly fixed to the distributor housing.

7. The distributor of claim 1 wherein the screed barrel is disposed above the plurality of outlets.

8. An agricultural toolbar configured for earthen manure injection, comprising:
an agricultural toolbar having a frame operably supporting one or more coulter blades;
a manure injection system operably attached to the frame, the manure injection system has a distributor housing with an inlet and a plurality of outlets for distributing a main flow of manure into a plurality of separate streams of manure;
a screed member disposed within the distributor housing in communication with the inlet of the distributor housing for receiving the main flow of manure, wherein the screed member includes a plurality of screed holes passing through a wall of the screed member;
a screed paddle disposed proximate the screed member, the screed paddle and screed member move relative to each other for screeding the main flow of manure through the plurality of screed holes to the plurality of outlets; and
a valve assembly disposed at an opening to each of the plurality of outlets, the valve assembly having an open position configured to communicate one of the plurality of separate streams of manure to a manure injector operably attached to the toolbar and a closed position configured to occlude manure flow to the manure injector.

9. The agricultural toolbar of claim 8 further comprising:
a control mechanism operably configured to the valve assembly to bias the opening to each of the plurality of outlets toward the closed position for distributing even amounts of the separate streams of manure to each manure injector.

10. The agricultural toolbar of claim 8 further comprising:
a manure conduit operably attached between each manure injector and each of the plurality of outlets.

11. The agricultural toolbar of claim 8 wherein the screed member comprises a screed barrel having an open end configured in communication with the inlet of the distributor housing and an opposite closed end in operably attached to the distributor housing.

12. The agricultural toolbar of claim 8 wherein the screed paddle is actuated against the screed member for screeding the main flow of manure through the plurality of screed holes to the plurality of outlets.

13. The agricultural toolbar of claim 8 wherein the screed member is actuated against the screed paddle for screeding the main flow of manure through the plurality of screed holes to the plurality of outlets.

14. The agricultural toolbar of claim 8 further comprising:
a pair of gate shafts biased in opposite directions, each gate shaft carries a plurality of gate valves, each of the plurality of outlets having one of the plurality of gate shafts.

15. A method for controlling earthen manure injection in agricultural applications, comprising:
providing a manure distributor housing having an inlet and a plurality of outlets for distributing a main flow of manure into a plurality of separate streams of manure;
introducing the main flow of manure into a screed barrel disposed within the distributor housing;
screeding the main flow of manure through a plurality of screed holes disposed in a wall of the screed barrel by moving a screed paddle against the wall of the screed barrel; and
biasing a gate valve disposed in each of the plurality of outlets to a closed position for distributing even amounts of the separate streams of manure from the screed barrel to a manure injector.

16. The method of claim 15 further comprising:
rotating a pair of gate shafts carrying a plurality of the gate valves in opposite directions to move each gate valve to a closed position.

17. The method of claim 15 further comprising:
actuating with a motor the screed paddle relative to the screed barrel.

18. The method of claim 15 further comprising:
opening the gate valve with the flow of manure from the screed barrel.

19. The method of claim 15 further comprising:
discharging the separate streams of manure to each manure injector proximate a coulter blade operably secured to an agricultural toolbar.

20. The method of claim 15 further comprising:
actuating with a motor the screed barrel relative to the screed paddle.
